(19) United States
(12) Patent Application Publication
(10) Pub. No.: US 2024/0424823 A1
(43) Pub. Date: Dec. 26, 2024

(54) DATA CARRIER WITH SECURED SURFACE PERSONALIZATION ELEMENT

(71) Applicant: THALES DIS FRANCE SAS, Meudon (FR)

(72) Inventor: Sébastien SUBRA, Auriol (FR)

(73) Assignee: THALES DIS FRANCE SAS, Meudon (FR)

(21) Appl. No.: 18/691,565

(22) PCT Filed: Sep. 13, 2022
(86) PCT No.: PCT/EP2022/075460

§ 371 Date: Mar. 13, 2024

(30) Foreign Application Priority Data
Sep. 14, 2021 (EP) 21306259.9

(51) Int. Cl. B42D 25/435; B42D 25/23; B42D 25/324; B42D 25/346

(52) U.S. Cl. CPC B42D 25/435; B42D 25/23; B42D 25/324; B42D 25/346

(57) ABSTRACT

Provided is a data carrier that extends along an extension axis and comprises a carrier body having a top surface, at least one personalization element being arranged on the top surface of the carrier body, and at least one security element. The security element is at least partially arranged at least on and/or in a top surface of the personalization element and at least partially at least on and/or in the top surface of the carrier body and/or at least partially within the carrier body. Other embodiments disclosed.

### TECHNICAL FIELD

The present invention relates to a data carrier according to claim 1, to a security document comprising or consisting of such a data carrier according to claim 14, and to a method of producing a data carrier according to claim 15.

### PRIOR ART

Data carriers for security documents such as identity cards, passports or the like typically comprise at least one personalization element such as an image of the holder of the data carrier. Said personalization element can be provided on a top surface of the data carrier, e.g. by printing a photograph of the holder. However, such personalization elements are prone to forgery. In fact, personalization elements being arranged on a top surface can be removed or replaced, for instance by re-printing a forged photograph onto the data carrier whose personalization element has previously been removed.

### SUMMARY OF THE INVENTION

It is an object of the present invention to provide a data carrier especially for a security document of greater security that is less prone to forgery.

This object is achieved with a data carrier according to claim 1. In particular, a data carrier is provided, wherein the data carrier extends along an extension axis and comprises a carrier body comprising a top surface, at least one personalization element being arranged on the top surface of the carrier body, and at least one security element. The security element is at least partially arranged at least on and/or in a top surface of the personalization element. The security element is furthermore at least partially arranged at least on and/or in the top surface of the carrier body and/or at least partially within the carrier body.

That is, the security element is arranged at least in a region of the personalization element as well as in a region of the carrier body. In other words both, the carrier body as well as the personalization element, comprise the security element.

Furthermore, a part of the security element is always provided at least on and/or in the top surface of the personalization element. Another part of the security element can be provided at least on and/or in the top surface of the carrier body, or within the carrier body, or at least on and/or in the top surface of the carrier body as well as within the carrier body, respectively.

The security element being arranged within the carrier body is preferably embedded within the carrier body.

The data carrier preferably comprises a top side and an opposing bottom side. The top surface of the carrier body is preferably comprised by or even constitutes the top side of the data carrier. An expansion direction extending parallel to the expansion axis preferably extends from the top side of the data carrier towards the bottom side of the data carrier. Hence, when seen along the expansion direction the personalization element is preferably arranged before the carrier body.

The security element can be an integral constituent of the personalization element and/or of the carrier body.

In other words, the security element is preferably not added to the personalization element and/or to the carrier body but is formed on and/or in them. Again in other words the security element is preferably not a separate constituent, but the personalization element and the security element and/or the carrier body and the security element are configured as a single-piece element.

The security element preferably has the shape of a pattern. Additionally or alternatively the security element can be laser engraved on and/or in the personalization element and/or in the carrier body. Laser engraving is an industry standard term commonly used for laser marking of plastic identity documents. To this end it should be noted that the expression laser marking as used herein preferably refers to laser marking including the so called tactile laser marking.

Additionally or alternatively the security element can be machine-readable or inspectable by the bare human eye.

The pattern can be an ordered pattern or a disordered pattern. An ordered pattern preferably comprises pattern elements being arranged in a repetitive manner. A disordered pattern preferably comprises randomly distributed pattern elements. The pattern elements in both cases can correspond to geometric shapes such as lines or circles or the like, a barcode, or any random looking set of elements. A security element being inspectable by the bare human eye is understood as being verifiable without the need of any dedicated equipment. A machine-readable security element is understood as being verifiable by means of dedicated equipment, e.g. by means of a mobile phone that takes a photograph of the security element and being configured to perform a software-based verification of the pattern. A phone operates in visible light regarding the light source as well as the capture. However, the verification could likewise require specific lighting conditions such as ultraviolet lighting or infrared lighting, and the same applied to the capturing device. Furthermore, the verification could require magnification of some level if the security element is provided at very high resolution.

The security element preferably is a surface structure and/or a perforation structure and/or a change of colour.

The security element being a surface structure is understood as being only arranged on and/or in the top surface of the personalization element. This case can be seen as a partial extension of the security element from or through at least a region of the personalization element. The security element being a perforation structure is understood as extending entirely through the personalization element. In any case, it is preferred that an extension of the security element from or through at least a region of the personalization element extends along the extension axis. Thus, the security element in the personalization element can be said to preferably extend from the top surface of the personalization element at least partially away from the personalization element or at least partially into or entirely through the personalization element with respect to the extension axis. Statements made herein regarding a security element being arranged on and/or in the top surface of the personalization element likewise apply to the security element extending at least partially into the personalization element as well as extending entirely through the personalization element and vice versa. Likewise, the security element being arranged at least partially on and/or in the top surface of the carrier body preferably extends from the top surface of the carrier body at least partially away from or into the carrier body with respect to the extension axis. Also here it should be noted that statements made herein regarding a security element being arranged on and/or in the top surface of the carrier body likewise apply to the security element extending at least partially into the carrier body as well as entirely through the carrier body and vice versa. The security element being a change of colour is understood as a change of the reflective properties or a change in opacity, i.e. a change in one or more visual or optical properties.

The security element being a perforation structure is preferably generated by irradiating electromagnetic radiation from a laser such as a carbon dioxide laser, which enables perforating holes into and through the data carrier. For instance, and as will be explained in greater detail below, the personalization element preferably is a print and the carrier body preferably comprises a layer such as a laser-engravable layer, wherein the irradiation of radiation could not only mark the print but could also generate perforations, i.e. holes through the print as well as the layer, whereby the perforated security element could be verified with a back light or transmission light. It should be noted that laser perforation with carbon dioxide lasers does not require any laserability of the layer of the carrier body. Instead, the carbon dioxide laser simply removes material of the layer independent of a colour or other characteristics of the layer.

The security element preferably exhibits an appearance which extends preferably uninterruptedly along the personalization element as well as along the carrier body with respect to a transverse axis running perpendicularly to the extension axis.

The uninterrupted appearance of the security element can also be seen as a continuous appearance, i.e. it is preferred that the part of the security element being arranged at least partially on and/or in the top surface of the personalization element and the part of the security element being arranged at least partially on and/or in the top surface of the carrier body and/or within the carrier body are arranged immediately adjacent to one another with respect to the transverse axis.

Hence, the security element can be said to comprise at least two parts. For instance, the security element could comprise a first part such as a first part of a pattern being arranged on and/or in the top surface of the personalization element and a second part such as a second part of said pattern being arranged on and/or in the top surface of the carrier body.

However, it is likewise conceivable that the security element comprises a first part being arranged on and/or in the top surface of the personalization element and a second part being arranged within the carrier body. To this end it is preferred that in the former case and in the latter case the first part of the security element and the second part of the security element are arranged immediately adjacent to one another with respect to the transverse axis running perpendicularly to the extension axis such that they constitute an uninterrupted or continuous pattern.

It is however likewise conceivable that the security element comprises further parts, for example three parts. In this case, for example, a first part such as a first part of a pattern could be arranged on and/or in the top surface of the personalization element, a second part such as a second part of the pattern could be arranged on and/or in the top surface of the carrier body, and a third part such as a third part of the pattern could be arranged within the carrier body. In this case it is also preferred that the first part of the security element and the second part of the security element and/or the third part of the security element are arranged immediately adjacent to one another with respect to the transverse axis running perpendicularly to the extension axis. For example, said part of the security element being provided within the carrier body and said part of the security element being provided on and/or in the top surface of the carrier body could both be arranged immediately adjacent to said part of the security element being arranged on and/or in the top surface of the personalization element with respect to the transverse axis such that they constituted an uninterrupted or continuous pattern.

In other words, if the transverse axis is seen as a horizontal axis and the extension axis is seen as a vertical axis, it is preferred that the two or more parts of the security element are arranged without a horizontal offset with respect to one another.

Again in other words it can be said that the security element preferably defines an area expansion with respect to a transverse axis running perpendicularly to the extension axis and which area expansion extends at least partially over the personalization element as well as over the carrier body and/or within the carrier body.

The security element on and/or in the top surface of the personalization element preferably corresponds to a relief structure. Additionally or alternatively, the security element on and/or in the top surface of the carrier body preferably corresponds to a relief structure. Additionally or alternatively the security element within the carrier body preferably corresponds to a marking structure comprising one or more marking elements, the one or more marking elements preferably being laser markings and/or opaque elements and/or bleached elements.

The relief structure of the personalization element and/or the relief structure of the carrier body preferably comprises recesses and/or protrusions.

The personalization element comprising recesses is understood as comprising recesses that extend from the top surface of the personalization element at least partially into the personalization element with respect to the extension axis, i.e. with respect to the extension direction. The personalization element comprising protrusions is understood as comprising protrusions that extend from the top surface of the personalisation element away from the personalization element with respect to the extension axis, i.e. along a direction extending opposite to the extension direction. Hence, the protrusions and the recesses of the personalization element can be said to extend along opposing directions. To this end it is conceivable that the personalization element comprises recesses and protrusions or either recesses or either protrusions.

Likewise, the carrier body comprising recesses is understood as comprising recesses that extend from the top surface of the carrier body at least partially into the carrier body with respect to the extension axis, i.e. with respect to the extension direction. The carrier body comprising protrusions is understood as comprising protrusions that extend from the top surface of the carrier body away from carrier body with respect to the extension axis, i.e. along a direction extending opposite to the extension direction. Hence, the protrusions and the recesses of the carrier body can be said to extend along opposing directions as well. To this end it is conceivable that carrier body comprises recesses and protrusions or either recesses or either protrusions.

A lateral distance between adjacent recesses is understood as the distance between two adjacent recesses with respect to the transverse axis. Likewise, a lateral distance between adjacent protrusions is understood as the distance between two adjacent protrusions with respect to the transverse axis.

Moreover, recesses in or protrusions from the top surface of the personalization element are defined with respect to a (fictitious) plane running through the top surface of the personalization element in regions of the personalization element that lack the security element. Said plane can thus be seen as a surface plane of the top surface of the personalization element. Likewise, recesses in or protrusions from the top surface of the carrier body are defined with respect to a (fictitious) plane running through the top surface of the carrier body in regions of the carrier body that lack the security element. Said plane can thus be seen as a surface plane of the top surface of the carrier body. A length expansion of a particular recess originating from the top surface of the personalization element or the top surface of the carrier body along the extension axis preferably is in the range of 100 nanometer to 1000 micrometer, more preferably in the range of 500 nanometer to 500 micrometer, particularly preferably 10 micrometer or less. Additionally or alternatively a width expansion of a particular recess along a transverse axis running perpendicularly to the extension axis preferably is in the range of 500 nanometer to 5 millimeter. Additionally or alternatively a lateral distance between adjacent recesses preferably is in the range of 500 nanometer to 5 millimeter. For instance, a ‘design’ with thin markings further away from each other as well as wider markings being closer to each other are conceivable. These dimensions are conceivable for recesses in the personalization element as well as in the carrier body.

The recesses in the personalization element and/or the recesses in the carrier body are particularly preferably generated by laser engraving.

A length expansion of a particular protrusion along the extension axis preferably is in the range of 100 nanometer to 1000 micrometer, more preferably in the range of 500 nanometer to 500 micrometer, particularly preferably 10 micrometer or less. Additionally or alternatively a width expansion of a particular protrusion along a transverse axis running perpendicularly to the extension axis preferably is in the range of 500 nanometer to 5 millimeter. Additionally or alternatively a lateral distance between adjacent protrusion preferably is in the range of 500 nanometer to 5 millimeter.

The protrusions from the personalization element and/or the protrusions from the carrier body are particularly preferably generated by laser engraving.

A length expansion of a particular marking element along the extension axis preferably is in the range of 100 nanometer to 1000 micrometer, more preferably in the range of 500 nanometer to 500 micrometer, particularly preferably 10 micrometer or less. Additionally or alternatively a width expansion of a particular marking element along a transverse axis running perpendicularly to the extension axis preferably is in the range of 500 nanometer to 5 millimeter. Additionally or alternatively a lateral distance between adjacent marking elements preferably is in the range of 500 nanometer to 5 millimeter.

A lateral distance between adjacent marking elements is understood as the distance between two adjacent marking elements with respect to the transverse axis.

Regarding the above dimensions the following is noted. A preferred length expansion of the recesses and protrusions preferably depends on a thickness of the personalization element. In the event that the personalization element is a print such as an inkjet print, see further below, a preferred length expansion is 10 micrometer or less. A width expansion preferably depends on the laser beam size used to generate the security element. For instance, a typical 500 dpi laser resolution means that the laser spot is around 50μ in diameter with ablation taking place in a smaller area in the center of the beam. To this end it should be noted that the laser spot size can be around 50μ, but the laser markings can be composed of a ‘repeated’ pattern of such spots resulting in e.g. lines and the lines may well further be composed of a number of ‘repeated’ spots across its width resulting into wider lines and so on. As such it is preferred that the width expansion is 50 micrometer or less. However, a continuous recess or protrusion is conceivable to be generated as well, wherein a width expansion can be larger, for instance larger than 1500μ or 1.5 mm such as 5 millimeter. A preferred lateral distance between adjacent recesses or protrusions preferably depends on an operation mode of the laser. For instance, if the laser used to generate the security element is operated in pulse mode and each pulse is applied after translation of the target location, the adjacent spots are separate recesses or protrusions and which may be 50μ or closer from each other.

The relief structure of the personalization element and/or the relief structure of the carrier body and/or the marking structure within the carrier body can be the same or different from one another.

Same structures could comprise a same length expansion, a same width expansion and a same length expansion, for example. Different structures could differ in their length expansion and/or their width expansion and/or their length expansion, for instance. Other examples encompass a same geometrical shape as compared to a different geometrical shape, etc.

The personalization element preferably is a print, particularly preferably a thermochromic ink and/or photochromic ink. Additionally or alternatively the personalization element is preferably provided by inkjet printing and/or thermal transfer printing such as dye sublimation and retransfer printing. Additionally or alternatively the personalization element can comprise at least one reactive element that is configured to react upon an irradiation of electromagnetic radiation, whereby a reacted element is generated. The reactive element preferably is a reactive pigment and/or a reactive additive and/or a reactive colorant. The reacted element preferably corresponds to an ablated element and/or an evaporated element and/or a protruding element and/or a colour changed element. Ablated elements and evaporated elements can be seen as removed elements, i.e. material of the personalization element being removed such that recesses are generated. Protruding elements can be seen as a material of the personalization element having an overthickness, e.g. having a foamy structure that takes more space and gives a raised feel as compared to a non-irradiated part of the personalization element. A colour changed element can be seen as an element of different reflective properties and/or change in opacity, etc. No material is preferably removed from or added to the colour changed element. Instead, it preferably corresponds to an element that underwent a change of colour only. However, a material removal and/or a material addition combined with a change of colour is conceivable as well.

The relief structure on and/or in the top surface of the personalization element preferably comprises the reacted elements. In other words, by irradiating electromagnetic radiation on the reactive elements, the relief structure is preferably formed.

The carrier body preferably comprises or consists of a C-doped layer and/or of at least one plastics and/or of one or more polymers. The carrier body preferably comprises or consists of polycarbonate and/or polyvinyl chloride and/or polyethylene terephthalate and/or polyethylene and/or cross-linked polyethylene and/or polypropylene and/or copolymers thereof and/or mixtures thereof. It is furthermore preferred that the carrier body is provided by means of one or more layers, i.e. it preferably corresponds to a layered structure. The carrier body particularly preferably corresponds to a card body as it is known in the field of the invention. In regions that lack the security element the card body is preferably transparent.

Additionally or alternatively the carrier body preferably is laser-engravable. In other words, the carrier body is preferably configured to interact with impinging electromagnetic radiation such, that a marking element is generated in the marking layer upon the irradiation of electromagnetic radiation. Thus, by irradiating electromagnetic radiation on the carrier body the marking structure is preferably formed. As mentioned initially, the marking element can correspond to a laser marking, an opaque element, or a bleached element. Such marking elements are preferred in the event that the security element is arranged within the carrier body. However, the marking element can also correspond to an ablated element and/or to an evaporated element and/or a protruding element. In fact, it is preferred that the security element on and/or in the top surface of the carrier body comprises marking elements such as ablated elements and/or evaporated elements and/or protruding elements, and wherein said marking elements form the relief structure on and/or in the top surface of the carrier body. Also in this case the ablated elements and evaporated elements can be seen as removed elements, i.e. material of the carrier body being removed such that recesses are generated. Protruding elements can be seen as a material of the carrier body having an overthickness, e.g. having a foamy structure that takes more space and gives a raised feel as compared to a non-irradiated part of the carrier body.

The personalization element preferably has the shape of an image and/or of an alphanumeric character.

Non-exhaustive examples of an image are a portrait or photograph or biometric information such as a fingerprint e.g. of the holder of the data carrier, an outline of a country, a national emblem, a state coat of arms, a state flag, a signature panel, geometric objects such as lines, circles, etc. Non-exhaustive examples of an alphanumeric character are a date of birth, a name, a social security number e.g. of the holder of the data carrier, an expiry date, etc. The personalization element can serve the purpose of attributing personalized information such as personal data of the holder of the data carrier to the data carrier.

The security element on and/or in the top surface of personalization element preferably generates a visual contrast with the personalization element. Additionally or alternatively the security element on and/or in the top surface of the carrier body and/or within the carrier body preferably generates a visual contrast with the carrier body.

A visual contrast can be a difference in brightness, in shininess, in opacity, in transparency, in translucency, in colour, etc. For instance, if the personalization element corresponds to a coloured image the visual contrast being generated by the security element in the personalization element could be a different colour of the personalization element in the region of the security element as compared to regions that lack the security element. An example of a visual contrast being generated by the security element on and/or in and/or within the carrier body could be a different opacity being provided by the security element in the form of opaque laser markings in and/or within the carrier body as compared to a transparent carrier body in regions of the carrier body that lack the security element.

The personalization element preferably further comprises at least one unravelling element, and wherein the security element on and/or in the top surface of the personalization element at least partially unravels the unravelling element.

The unravelling element is preferably a part of the personalization element. The unravelling element is furthermore preferably arranged after the top surface of the personalization element with respect to the extension axis. It is furthermore preferred that an appearance, in particular one or more colours, of the unravelling element differs from an appearance, in particular on or more colours, of other parts of the personalization element. The unravelling element particularly preferably corresponds to a part of a print such as a part of an inkjet print and/or screen-printing ink and/or thermochromic ink and/or photochromic ink. Upon the generation of the security element on and/or in the top surface of the personalization element, the part of the print being provided by the unravelling element is preferably revealed towards an outside of the data carrier and thus made visible to an observer. For example, the personalization element could be a print of white ink and black ink, wherein the black ink covers the white ink. The generation of the security element in the personalization element could comprise the selective removal of the black ink, for instance by laser engraving the black ink. As a consequence, the white print would be unravelled in the regions of the laser engravings. The white ink can be said to constitute the unravelling element.

In another aspect a security document is provided, wherein the security document comprises or consists of at least one data carrier as described above. The security document preferably is a smart card, an identity card, a passport, a credit card, a bank note or the like.

It should be understood that the data carrier per se can correspond to a security document. This is the case if the data carrier is provided in the form of an identity card, for example. However, it is likewise conceivable to introduce or incorporate the data carrier into a security document. In the case of a passport, for example the data carrier could correspond to or could be incorporated in a page of the passport.

Any explanations made herein with regard to the data carrier likewise apply to the security document comprising the data carrier and vice versa.

In another aspect a method of producing a data carrier extending along an extension axis, preferably a data carrier as described above, is provided. The method comprises steps of (i) providing a carrier body comprising a top surface, (ii) providing at least one personalization element being arranged on the top surface of the carrier body, and (iii) providing at least one security element. The security element is at least partially arranged at least on and/or in a top surface of the personalization element. The security element is furthermore at least partially arranged at least on and/or in the top surface of the carrier body and/or at least partially within the carrier body.

Any explanations made herein with regard to the data carrier or the security document comprising the data carrier preferably likewise apply to the method of producing the data carrier and vice versa.

It is preferred that method steps (i) to (iii) are performed in this order. That is, it is preferred to provide a carrier body in a first step. Subsequently, it is preferred to provide a personalization element on the top surface of the carrier body, for example by printing a photograph onto the top surface of the carrier body in a second step. Subsequently, it is preferred to generate the security element on and/or in both the personalization element and the carrier body, for instance by laser engraving the personalization element and the carrier body.

The security element is preferably generated by irradiating electromagnetic radiation onto the personalization element and the carrier body. It is thus preferred to use a source of radiation, in particular a laser. Various commercially available lasers are conceivable. For instance, a carbon dioxide laser, a fibre laser or a YAG laser could be used.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a top view on a data carrier comprising a carrier body, a personalization element and a security element;

FIG. 2a shows a sectional view of a carrier body comprising a top surface;

FIG. 2b shows a sectional view of a data carrier comprising the carrier body according to FIG. 2a, wherein a personalization element has been added to the top surface of the carrier body;

FIG. 2c shows a sectional view of the data carrier body according to FIG. 2b, wherein a security element has been arranged in the personalization element and the carrier body;

FIG. 3a shows a sectional view of the data carrier according to FIG. 2c after manipulation, wherein the personalization element has been removed from the data carrier;

FIG. 3b shows a sectional view of the data carrier according to FIG. 3a after forgery, wherein a forged personalization element has been added to the data carrier;

FIG. 4a shows a top view of a data carrier comprising a personalization element and an unravelling element in an unravelled state;

FIG. 4b shows a top view of the data carrier according to FIG. 4a that furthermore comprises a security element, wherein the security element unravels the unravelling element;

FIG. 5a shows a top view of a data carrier comprising a personalization element and an unravelling element in an unravelled state;

FIG. 5b shows a top view of the data carrier according to FIG. 5a that furthermore comprises a security element, wherein the security element unravels the unravelling element.

### DESCRIPTION OF PREFERRED EMBODIMENTS

Aspects of the invention shall be further illustrated with reference to the figures.

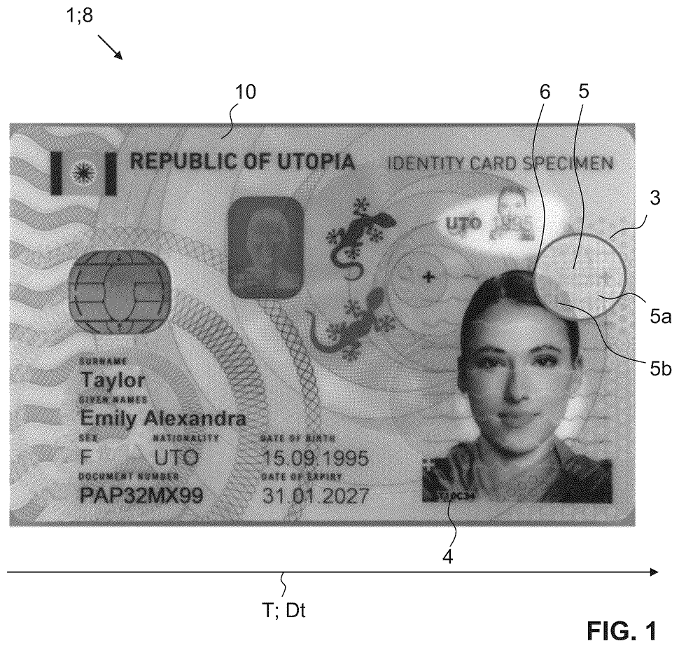

FIG. 1 depicts a data carrier 1 in the form of an identity card, i.e. the data carrier 1 corresponds here to a security document 8. Said data carrier 1 comprises a top side 10 and an opposing bottom side (not visible), wherein a personalization element 4 is arranged on the top side 10 of the data carrier 1.

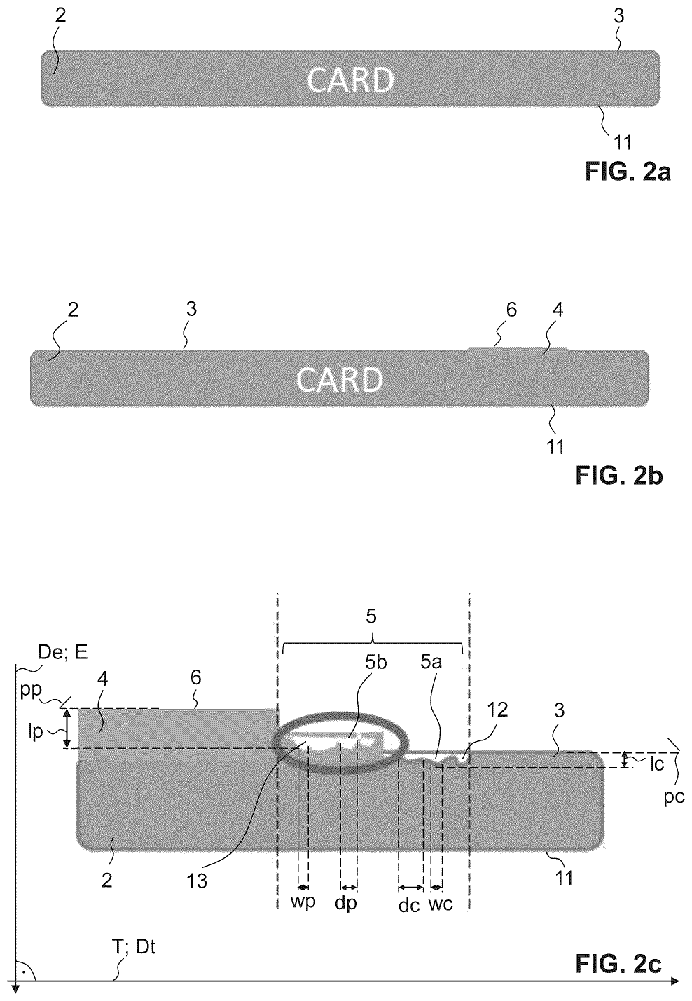

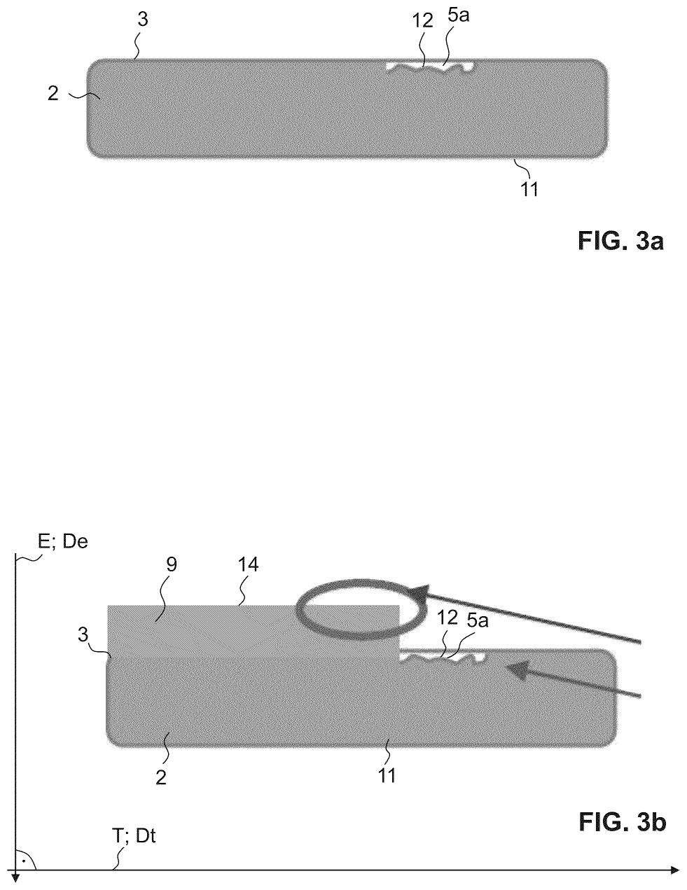

As will become apparent from FIGS. 2a to 3b, the data carrier 1 furthermore comprises a carrier body 2. Said carrier body 2 defines a top surface 3 and an opposing bottom surface 11. In the depicted example, the top surface 3 of the carrier body 2 constitutes the top side 10 of the data carrier 1. Hence, the personalization element 4 can be said to be arranged on the top surface 3 of the carrier body 2. The personalization element 4 has here the shape of an image being a portrait of the holder of the data carrier 1 and furthermore corresponds to a print. In other words, the personalization element 4 is a surface print on the data carrier 1.

Furthermore, the data carrier 1 comprises a security element 5 according to the invention, wherein said security element 5 is partially arranged in the region of the personalization element 4 as well as partially in the region of the carrier body 2. To this end it should be noted that a part 5b of the security element 5 is always provided at least on and/or in the top surface 6 of the personalization element 4. Another part 5a of the security element 5 is provided here in the top surface 3 of the carrier body 2. Although not depicted it is likewise conceivable that a part of the security element 5 is additionally provided within the carrier body 2 or instead of being provided in the top surface 3 of the carrier body 2.

When producing the data carrier 1 according to the invention it is preferred to provide a carrier body 2 in a first step, see FIG. 2a. In a second step the personalization element 4 is printed on a region of the top surface 3 of the carrier body 2, see FIG. 2b. In a third step, the security element 5 is generated in a part 5b of the personalization element 4 and in a part 5a of the carrier body 2, see FIG. 2c. Here, said security element 5 corresponds to a relief structure that is formed in the top surface 3 of the carrier body 2 and in a top surface 6 of the personalization element 4. In the depicted example, the carrier body 2 corresponds to a C-doped layer that is laser-engravable. Consequently, the irradiation of electromagnetic radiation onto the carrier body 2 generates marking elements 12 in the carrier body 2 that correspond here to ablated elements or evaporated elements. The personalization element 4 corresponds to a print comprising reactive elements that are configured to react upon an irradiation of electromagnetic radiation, whereby reacted elements 13 are generated. The reactive elements are reactive pigments and/or reactive additives and/or reactive colorants, whereby the reacted elements 13 correspond to ablated elements or evaporated elements as well. As readily follows from FIG. 2c, the reacted elements 13 in the personalization element 4 and the marking elements 12 in the carrier body 2 form a relief structure that is formed in the top surface 6 of the personalization element 4 and in the top surface 3 of the carrier body 2.

Moreover, the relief structure, and thus the security element 5, is an integral constituent of the personalization element 4 and of the carrier body 2. The relief structure 5 can also be seen as a pattern that is constituted by the reacted elements 13, which form here recesses 13, in the personalization element 4 and the marking elements 12, which form here recesses 12 as well, in the carrier body 2. As furthermore follows from FIG. 2c, the relief structure 5 of the personalization element 4 and of the carrier body 2 comprises in each case recesses 12, 13, wherein a length expansion lp, lc of a particular recess 12, 13 in the personalization element 4 and the carrier body 3 along an extension direction running parallel to the extension axis E is in the range of 10 micrometer to 200 micrometer. A width expansion wp, wc of a particular recess 13 in the personalization element 4 and in the carrier body 2 along a transverse direction Dt running parallel to the transverse axis T and perpendicularly to the extension direction De is in the range of 50 micrometer to 900 micrometer. A lateral distance dp, dc between adjacent recesses 12, 13 in the personalization element 4 and the carrier body 2, respectively, is in the range of 50 micrometer to 900 micrometer with respect to the transverse axis T or the transverse direction Dt.

Recesses 13 in the top surface 6 of the personalization element 4 are defined with respect to a plane pp running through the top surface 6 of the personalization element 4 in regions of the personalization element 4 that lack the security element 5. Said plane pp is seen as a surface plane pp of the top surface 6 of the personalization element 4. Recesses 12 in the top surface 6 of the carrier body 2 are defined with respect to a plane pc running through the top surface 3 of the carrier body 2 in regions of the carrier body 2 that lack the security element 5. Said plane pc is seen as a surface plane pc of the top surface 3 of the carrier body 2.

The security element 5, here the relief structure, exhibits an appearance which extends uninterruptedly along the personalization element 4 as well as along the carrier body 2 with respect to the transverse axis T or the transverse direction Dt running perpendicularly to the extension axis E or the extension direction De, respectively. The uninterrupted appearance of the security element 5 can also be seen as a continuous appearance, i.e. the part 5b of the security element 5 being arranged in the top surface 6 of the personalization element 4 and the part 5a of the security element 5 being arranged in the top surface 3 of the carrier body 2 are arranged immediately adjacent to one another with respect to the transverse axis T or the transverse direction Dt. In other words, if the transverse axis T is seen as a horizontal axis and the extension axis E is seen as a vertical axis, the two parts 5a, 5b of the security element 5 are arranged without a horizontal offset with respect to one another. Furthermore, the security element 5 can be said to define an area expansion with respect to the transverse axis T or the transverse direction Dt, and which area expansion extends at least partially over the personalization element 4 as well as over the carrier body 2.

FIGS. 3a and 3b depict the data carrier 1 being subject to forgery. In fact, FIG. 3a depicts the data carrier 1 as described above, wherein the personalization element 4 has been removed. Consequently, said part 5b of the security element 5 being provided in the personalization element 4, here the relief in the top surface 6 of the personalization element 4, is removed as well. As a result, the data carrier 1 only comprises the part 5a of the security element 5 being provided in the carrier body 2, here the relief or the recesses or marking elements 12 in the top surface 3 of the carrier body 2. When forgers add a forged personalization element 9 such as a forged image to the data carrier 1, said forged personalization element 9 would not comprise the part 5a of the security element 5 of the original or authentic personalization element 4. Instead, the forged personalization element 9 will comprise an even top surface 14, see FIG. 3b. The absence of the part 5b of the security element 5 in the personalization element 4 will make the forgery readily recognizable to an observer of the data carrier 1.

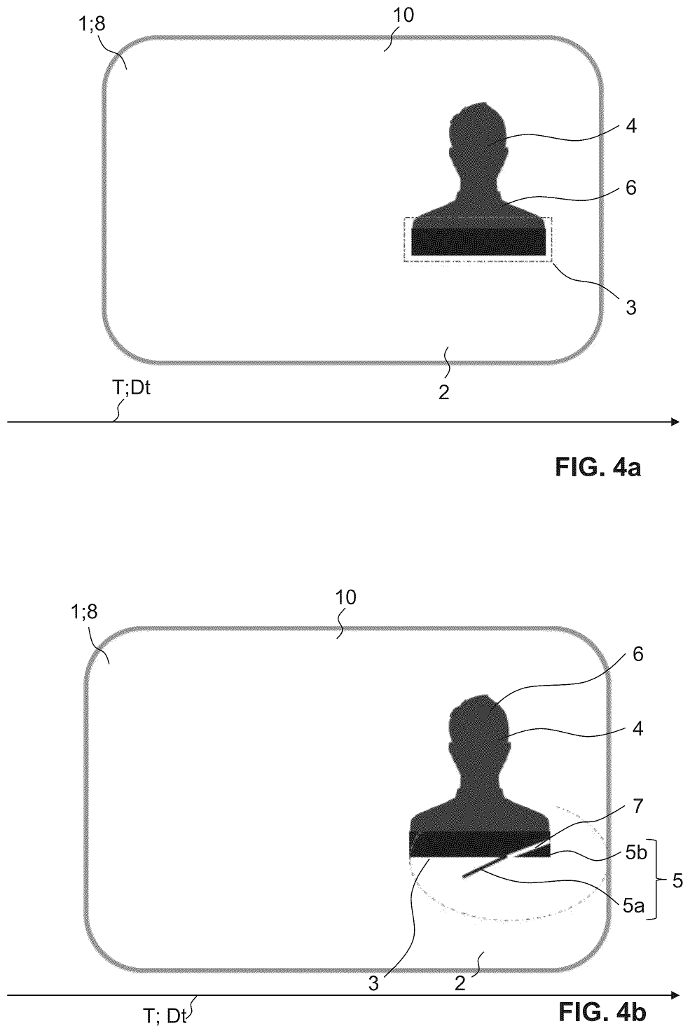

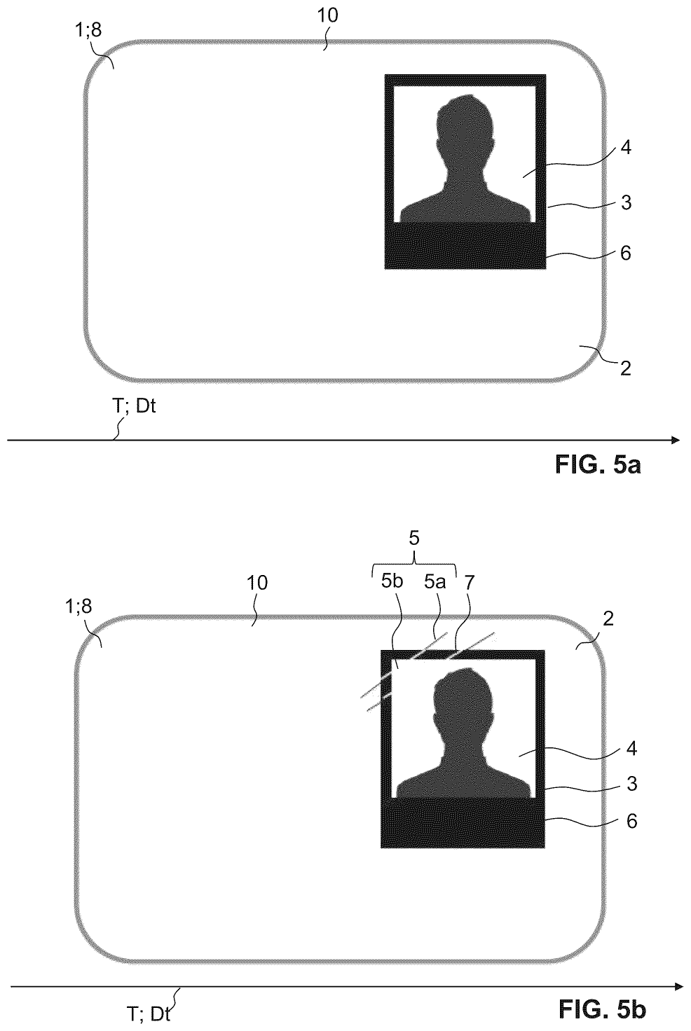

FIGS. 4a and 4b as well as FIGS. 5a and 5b in each case depict a data carrier 1 comprising a personalization element 4 having an unravelling element 7. To this end FIGS. 4a and 5a depict the data carrier 1 in the absence of a security element 5 and with the unravelling element 7 in an unravelled state. FIGS. 4b and 5b depict the data carrier 1 in the presence of a security element 5, wherein the security element 5 unravels the unravelling element 7. The unravelling element 7 is part of the personalization element 4 and is arranged after the top surface 6 of the personalization element 4 with respect to the extension axis E and the extension direction De. An appearance of the unravelling element 7 differs from an appearance of other parts of the personalization element 4. Here, the unravelling element 7 corresponds to white colour, whereas other parts of the personalization element 4, in particular a region of the untreated or non-irradiated top surface 6 of the personalization element 4, is of black colour. Upon the generation of the security element 5b in the top surface 6 of the personalization element 4, the irradiation of electromagnetic radiation selectively ablates or evaporates the personalization element 4 in the region of its top surface 6, whereby the unravelling element 7 is revealed towards an outside of the data carrier 1 and thus made visible to an observer. Thereby, additional security is added to the personalization element.

LIST OF REFERENCE SIGNS

| | | | |
|---|---|---|---|
| 1 | data carrier | | |
| 2 | carrier body | E | extension axis |
| 3 | top surface | T | transverse axis |
| 4 | personalization element | De | extension direction |
| 5 | security element | Dt | transverse direction |
| 5a | part of security element | lp | length expansion |
| 5b | part of security element | lc | length expansion |
| 6 | top surface | lm | length expansion |
| 7 | unravelling element | wp | width expansion |
| 8 | security document | wc | width expansion |
| 9 | forgery element | wm | width expansion |
| 10 | top side | dp | distance |
| 11 | bottom surface | dc | distance |
| 12 | marking element | dm | distance |
| 13 | reacted element | pp | plane |
| 14 | top surface | pc | plane |

1. A data carrier extending along an extension axis (E) and comprising:
a carrier body comprising a top surface;
at least one personalization element being arranged on the top surface of the carrier body; and
at least one security element,
wherein the security element is at least partially arranged at least on and/or in a top surface of the personalization element and at least partially at least on and/or in the top surface of the carrier body and/or at least partially within the carrier body.

2. The data carrier according to claim 1, wherein the security element is an integral constituent of the personalization element and/or of the carrier body.

3. The data carrier according to claim 1, wherein the security element has the shape of a pattern, and/or
wherein the security element is laser engraved on and/or in the personalization element and/or in the carrier body, and/or
wherein the security element is machine-readable or inspectable by the bare human eye, and/or
wherein the security element is a surface structure and/or a perforation structure and/or a change of colour.

4. The data carrier according to claim 1, wherein the security element exhibits an appearance which extends preferably uninterruptedly along the personalization element as well as along the carrier body with respect to a transverse axis (T) running perpendicularly to the extension axis (E).

5. The data carrier according to claim 1, wherein the security element on and/or in the top surface of the personalization element corresponds to a relief structure, and/or
wherein the security element on and/or in the top surface of the carrier body corresponds to a relief structure, and/or
wherein the security element within the carrier body corresponds to a marking structure comprising one or more marking elements, the one or more marking elements preferably being laser markings and/or opaque elements and/or bleached elements.

6. The data carrier according to claim 5, wherein the relief structure of the personalization element and/or the relief structure of the carrier body comprises recesses and/or protrusions,
wherein a length expansion (lp, lc) of a particular recess and/or a length expansion of a particular protrusion along the extension axis (E) is in the range of 100 nanometer to 1000 micrometer, preferably in the range of 500 nanometer to 500 micrometer, particularly preferably 10 micrometer or less, and/or
wherein a width expansion (wp, wc) of a particular recess and/or of a particular protrusion along a transverse axis (T) running perpendicularly to the extension axis (E) is in the range of 500 nanometer to 5 millimeter, and/or
wherein a lateral distance (dp, dc) between adjacent recesses and/or between adjacent protrusions with respect to the transverse axis (T) is in the range of 500 nanometer to 1500 micrometer.

7. The data carrier according to claim 5, wherein a length expansion (lm) of a particular marking element along the extension axis (E) is in the range of 100 nanometer to 1000 micrometer, preferably in the range of 500 nanometer to 500 micrometer, particularly preferably i10 micrometer or less, and/or
wherein a width expansion (wm) of a particular marking element along a transverse axis (T) running perpendicularly to the extension axis (E) is in the range of 500 nanometer to 5 millimeter, and/or
wherein a lateral distance (dm) between adjacent marking elements is in the range of 500 nanometer to 5 millimeter.

8. The data carrier according to claim 7, wherein the relief structure of the personalization element and/or the relief structure of the carrier body and/or the marking structure within the carrier body are the same or different from one another.

9. The data carrier according to claim 5, wherein the personalization element is a print, preferably a thermochromic ink and/or photochromic ink and/or preferably provided by inkjet printing and/or thermal transfer printing, and/or
wherein the personalization element comprises at least one reactive element that is configured to react upon an irradiation of electromagnetic radiation, whereby a reacted element is generated, the reactive element preferably being a reactive pigment and/or a reactive additive and/or a reactive colorant and/or the reacted element preferably corresponding to an ablated element and/or an evaporated element and/or a protruding element and/or a colour changed element.

10. The data carrier according to claim 5, wherein the carrier body comprises or consists of a C-doped layer and/or of at least one plastics and/or of one or more polymers, and/or
wherein the carrier body is laser-engravable.

11. The data carrier according to claim 1, wherein the personalization element has the shape of an image and/or of an alphanumeric character.

12. The data carrier according to claim 1, wherein the security element on and/or in the top surface of personalization element generates a visual contrast with the personalization element, and/or
wherein the security element (5) on and/or in the top surface (3) of the carrier body (2) and/or within the carrier body (2) generates a visual contrast with the carrier body (2).

13. The data carrier according to claim 1, wherein the personalization element further comprises at least one unravelling element, and
wherein the security element on and/or in the top surface of the personalization element at least partially unravels the unravelling element.

14. A security document comprising or consisting of at least one data carrier comprising:
a carrier body comprising a top surface;
at least one personalization element being arranged on the top surface of the carrier body; and
at least one security element.
wherein the security element is at least partially arranged at least on and/or in a top surface of the personalization element and at least partially at least on and/or in the top surface of the carrier body and/or at least partially within the carrier body,
wherein the security document is a smart card, an identity card, a passport, a credit card, or a bank note.

15. A method of producing a data carrier extending along an extension axis (E) the method comprising the steps of:
(i) Providing a carrier body comprising a top surface,
(ii) Providing at least one personalization element being arranged on the top surface of the carrier body, and
(iii) Providing at least one security element,
wherein the security element is at least partially arranged at least on and/or in a top surface of the personalization element and at least partially at least on and/or in the top surface of the carrier body and/or at least partially within the carrier body
wherein the date carrier comprises:
a carrier body comprising a top surface;
at least one personalization element being arranged on the top surface of the carrier body; and
at least one security element.
